(19) United States
(12) Patent Application Publication
(10) Pub. No.: US 2022/0329050 A1
(43) Pub. Date: Oct. 13, 2022

(54) SYSTEMS AND METHODS FOR AN ELECTRIC POWERED SERVICE RIG

(71) Applicant: High Arctic Energy Services Inc., Calgary (CA)

(72) Inventor: Cory Duncan, Calgary (CA)

(21) Appl. No.: 17/718,490

(22) Filed: Apr. 12, 2022

Related U.S. Application Data
(60) Provisional application No. 63/173,739, filed on Apr. 12, 2021.

(51) Int. Cl. H02B 1/20; E21B 19/08; E21B 41/00

(52) U.S. Cl. CPC H02B 1/20; E21B 19/08; E21B 41/00

(57) ABSTRACT

The usage of medium/high voltage to work on oil and gas wells with service/workover rigs, snubbing jacks, coil tubing injectors and continuous rod injectors is disclosed. The electric power may be supplied by high voltage power transmission lines or a generator. The electricity may be used to power electric motors which drive hydrostatic pumps, or hydraulic pumps to operate the hoisting device, commonly referred to as drawworks with rigs, jack cylinders with snubbing jacks and injectors with coil tubing and continuous rod injectors in addition to the other hydraulic needs such as controls, winches, tubing tongs and power swivels.

### FIELD

This disclosure is directed to service rigs and related equipment such as workover rigs, snubbing jacks, coiled tubing injectors and continuous rod injectors. More particularly, this disclosure is directed to the use of medium to high voltage electricity to supply the rig.

### BACKGROUND

Oilfield wells routinely require the use of a service rig to conduct maintenance on oil and gas wells when the components within the wellbore need to be replaced or inspected. When the oil and gas wells need to have work performed in the oil and gas formations, a service or workover rig may be required.

A service rig and a workover rig are similar with minor differences being the ancillary support equipment that is provided within the rig package and is not part of the actual rig itself.

A snubbing jack may be used to install or remove tubing into the wellbore while the well has the presence of high-pressure gas or to use the snubbing jack's rotary functions to perform various rotational operations within the wellbore.

A coil tubing injector may be used to install and remove continuous tubing into and out of the wellbore to perform service and workover operations.

A continuous rod injector may be used to install and remove continuous sucker rod from the wellbore in relation to downhole pumping operations.

### SUMMARY

A system for powering equipment for installing or removing tubing and/or sucker rod for an oil and gas wellbore is disclosed. The system comprises a transformer to convert received electrical power into a medium/high voltage power, one or more transmission cables for supplying the converted electric power to a service/workover rig, snubbing jack, coil tubing injector or continuous rod injector, and one or more electric drive motors, powered by the converted electric power transmitted by the one or more transmission cable in the service/workover rig, snubbing jack, coil tubing injector or continuous rod injector.

The system may further include one or more hydraulic or hydrostatic pumps coupled to the one or more electric drive motors, wherein the one or more hydraulic or hydrostatic pumps are coupled to one or more hydraulic equipment used in the installing or removing tubing and/or sucker rod for an oil and gas wellbore.

### BRIEF DESCRIPTION OF THE DRAWINGS

In drawings which illustrate by way of example only a preferred embodiment of the disclosure,

FIG. 1 is an overhead view of an oil and gas pad style wellsite including electrical components.

FIG. 2 is a view of power supply buildings on-site with a trailer containing the electrical transformers and electric motor drive components.

FIG. 3 is a view of an electric transmission cable used with drive motors at the wellbore.

FIG. 4 is a view of the drive motors with hydrostatic pumps and hydrostatic motors in a service rig or workover rig application.

FIG. 5 is a view of the electrical components inside the electrical trailer and their usage.

### DETAILED DESCRIPTION

An embodiment uses electricity to power the drive mechanism for the installation and removal of tubing and sucker rod from the well bore on oil and gas wells. The electricity may be provided from high voltage power transmission lines, from an on site generator powered by diesel fuel, natural gas or dual fuel diesel/natural gas or from another source.

Preferably the electric power source is one or more high voltage power transmission lines. By using transmission lines, such as from the electrical grid, no on site diesel generator is required reducing the noise on site and pollution. Using power from transmission lines also reduces or the eliminates the need to re-fuel diesel engines at the wellsite, reducing the risks to operators and operating costs.

The medium/high voltage electrical power may be transmitted through electrical cables to the electric drive motors on the well site.

The medium/high voltage power may be obtained directly from the grid/transmission lines. Alternatively, the voltage may be altered using a transformer either on or off site to be in the medium/high range.

If low voltage power is available, the power may be converted to a medium/high voltage through the use of a step-up transformer. In some cases, low voltage power may be already available at the well site, such as from low voltage transmission lines. Low voltage power may be provided by a diesel, natural gas or dual-fuel generator or other similar source.

As used in this disclosure low voltage refers to voltage less than about 800V, typically around 600-800V. Medium/high voltage as used in the systems described below for the distribution of power within the well site is about 2000-5000V and preferably at around 4160V.

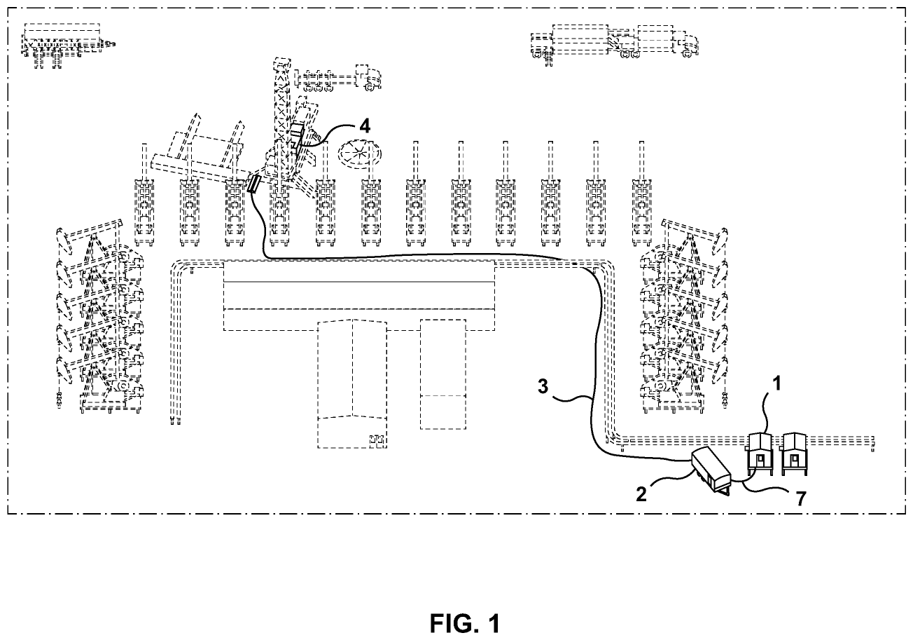

With reference to FIG. 1, a wellsite may have wellbore used for the extraction of oil or gas in the oil and gas industry. In an embodiment, the wellsite may have an electrical power supply on-site 1 generated from hydrocarbons, such a diesel, natural gas or duel fuel diesel/natural gas generator. The generator may be inside a suitable housing such as buildings or trailer. The housing may include electrical connection panels, circuit breakers and motor controls. The housing may be positioned away from the wellsite to isolate the noise of the generator from the operators at the well site.

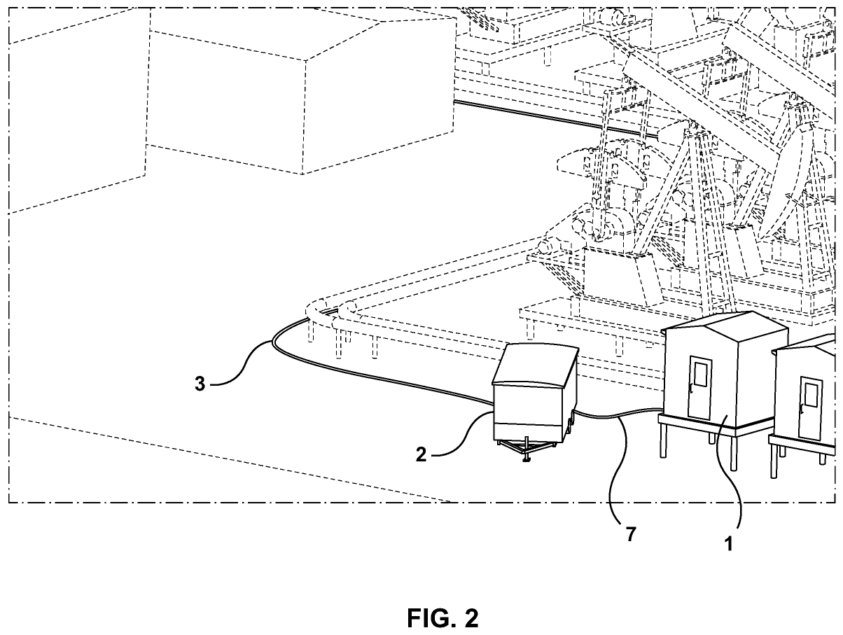

An electrical trailer 2, either separate from, or combined with housing 1, may contain one or more transformers 16 as well as electric motor drive components, such as soft starts 15, electrical connections and terminations. A preferred configuration may include a circuit with a step-up transformer, soft start and medium/high voltage cable for each electrical motor in operation. Having separate components for each electric motor, may improve the reliability/redundancy of the system in the event a component fails or is unavailable for a period of time. Having separate components may decrease the cost of the components because the power rating may be less than a similar component suitable for powering all the electric motors. These motor drive components may be housed with the electric motor or, with reference to FIG. 2, separate from the motor. The motor drive components may be housed separately due to their size, to more easily make the various components transportable.

An electrical transmission line 3 may conduct electrical power to the equipment utilizing the electric power such as motors 4. Electrical transmission line 3 transmits the electrical power at medium/high voltage. Since the motors typically require significant power, by transmitting the electrical power by medium/high voltage, the current in the cables is reduced, and hence reducing the size of the cables as compared to using lower voltage. Reducing the size of the cables, makes it easier to transport the cables to the site, makes the cables more flexible, for ease of handling, allows the cables to be stored in a smaller area, makes the cables easier and faster to manually deploy, and easier for other equipment to navigate the cables, such as by driving or walking over them using ramps 20. Higher voltage cables also increase the potential length of the cables with less voltage drop allowing for longer distances of transmission than a low voltage cable. A medium/high voltage cable, as described for the electrical transmission line 3 may be approximately 1 inch diameter. Electrical transmission cable 3 may need to be 50-300 m in length to cross the well site and avoid equipment and high traffic areas of the well site.

With reference to FIG. 2, if the electrical trailer 2 and housing 1 are separate, the electrical trailer 2 may be connected to the power supply housing 1 through an electrical cable 7. The electrical cable 7 transmits the power from the power supply to the electrical transformers in the electrical trailer 2. Electrical cable 7 may transmit power at either high, medium, or low voltage depending on the power supply 1. If the power source is from grid connected transmission lines, the housing 1 may not be required.

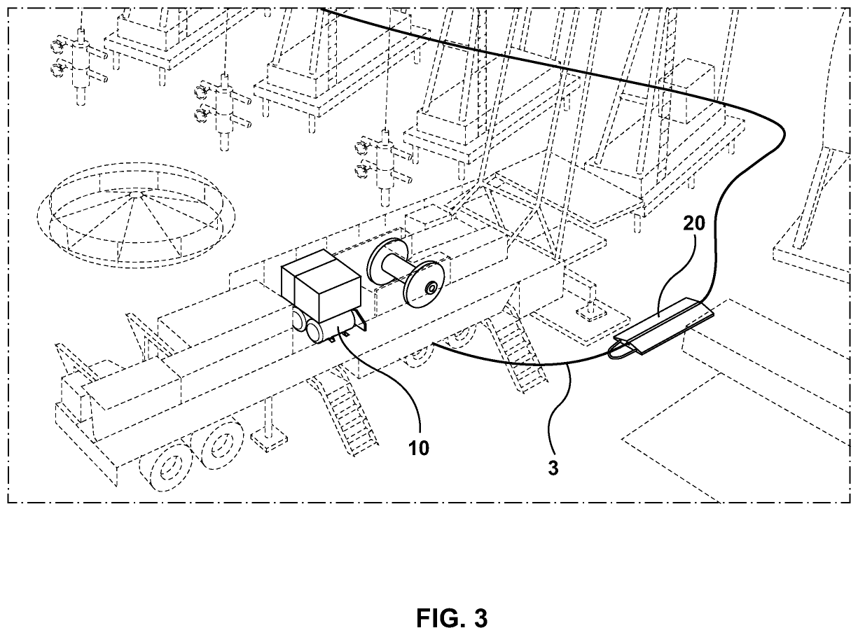

With reference to FIG. 3, the electrical transmission cable 3 may be connected from the electrical trailer 2 to the electric motors 10 and is transmitting medium/high voltage across the wellsite. The electrical transmission cable may be suitable protected from damage such as with vehicle ramps 20, protective covers or cladding (not shown), or other means.

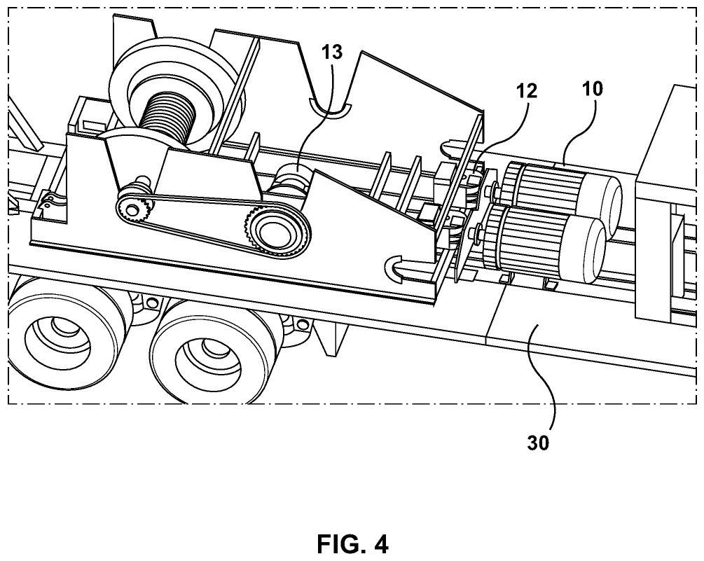

With reference to FIG. 4, the electric motors 10 may be coupled to hydrostatic pumps 12. One or more electric motors 10 may be used, such as using two motors in parallel to increase the hydraulic flow at the same pressure as a single motor. This may provide increase flow and redundancy in the event an electric motor, its motor control or transformer fails.

The hydrostatic pumps 12 may provide hydraulic pressure and flow to one or more hydrostatic motors 13. The hydrostatic motor 13 may provide rotational torque and speed, such as to power the main drum. The electrical motor 10 and hydrostatic pumps 12 may be contained within a mobile unit 30 such as wheeled trailer. The electrical motors may be controlled with the torque and speed needed for the particular needs of the system. In a preferred arrangement, the electrical motors may drive the hydrostatic pumps 12 at a substantially stable speed.

The hydrostatic motors 13 may be connected through hosing and valving to hydraulic cylinders which are used to provide the linear force to install or remove tubing for an oil and gas wellbore for a snubbing jack application. The hydraulic pumps may be connected through hosing and valving to hydraulic drive motors which are used to provide rotational torque and speed required to drive a chain system utilizing gripper blocks for installation and removal of continuous coil tubing for an oil and gas wellbore for a coil tubing injector application or for installation and removal of continuous sucker rod for an oil and gas wellbore for a continuous rod injector application.

The electric motors 10, or separate electric motors, may also be coupled to one or more auxiliary hydraulic pumps. The auxiliary hydraulic pumps may be used to operate clutches, brakes, power tongs, winches and other functions.

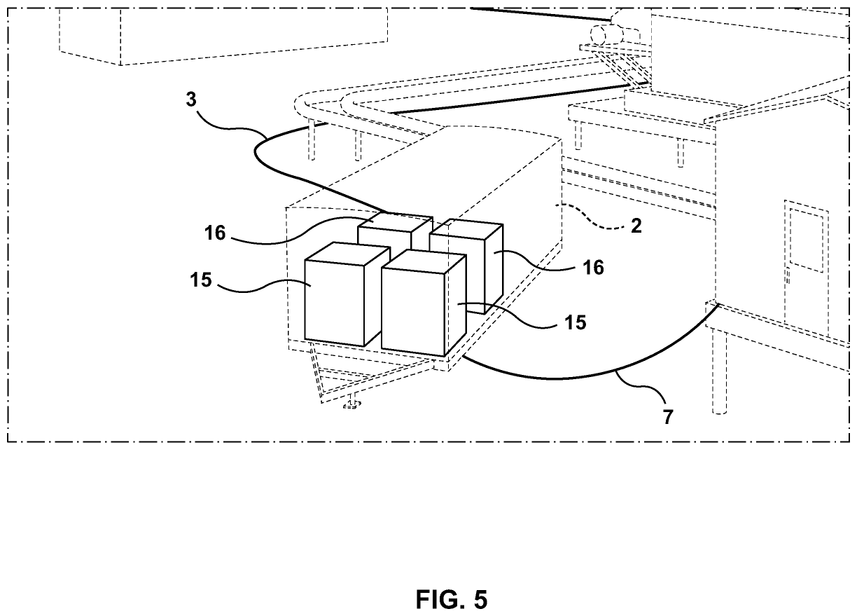

With reference to FIG. 5, the electric components may be situated in the electrical trailer 2 (shown cut away). The electric components may include one or more soft start relays 15 that provide the electrical drive for the electric motors. The electric components may also include the transformers 16 that convert the electrical supply to a medium/high voltage. The transformers 16 receive the power supply from the power supply 1 via power cable 7. The medium/high voltage is transmitted through the transmission cable 3 to the electric motors.

A service rig or workover rig operate with an existing wellbore and are typically on site for several days. The rig must therefore be portable, and there are benefits to having a rig that can be easily moved to reduce movement downtime between wellbores. Auxiliary engines, such as diesel engines, may be used for transporting the trailers or other components between well sites and for powering the hydrostatic pumps during setup and takedown, or when electrical power is not available.

To work on the oilfield wells, a service rig/workover rig typically uses a tall mast structure to provide the height to pull lengths of rods or tubulars from the wellbore. To accomplish the mechanical means of pulling the rods and tubulars, one method utilizes a block and tackle system that uses a large hoisting winch referred to as a drawworks. Snubbing jacks using hydraulic cylinders provide the pulling and pushing forces to install and remove tubing. The coil tubing and continuous rod injectors may use a chain drive with gripper blocks to insert or remove continuous tubing or continuous sucker rod from the wellbore.

Service/workover rigs, snubbing jacks, coiled tubing injectors and continuous rod injectors are typically powered by a diesel engine (or in some cases, natural gas or dual fuel diesel-natural gas engine) which provides the mechanical means to drive the drawworks or provides the drive source for the hydraulic pumps to operate the jack cylinders, continuous tubing drive motors, continuous rod drive motors, winches, power tongs and the engine may also drive the air compressor to provide air for the controls and air clutches. The diesel engine may also be used to propel the transportation drive wheels for moving the equipment on roads to various well sites.

For a service/workover rig, with a conventional diesel-powered drive system, a diesel engine drives a transmission with multiple gear options selected by supplying hydraulic pressure to a series of clutch packs. The power may be transmitted through the transmission, to a driveshaft coupled with u-joints, then to a right-angle gear box utilizing a gear set to transfer the rotational drive at a 90-degree angle. The power may then be transmitted from the right-angle box to a chain drive that provides rotational torque to the air operated clutches for the sandline drum shaft and then to the main drum shaft. The rotational torque may be used to turn the sand line and main drum winches through the use of air clutches using either a multi-disc clutch pack, or a circular clutch surrounding the outer circumference of the clutch hub.

For the snubbing jack, coil tubing injector and continuous rod injector, the conventional diesel may power a drive system using an internal combustion engine to drive hydraulic pumps. The hydraulic pumps may provide pressure and flow to extend and retract the hydraulic cylinders in the snubbing jack and rotate drive motors on the coil tubing injector and the continuous rod injector.

The use of the diesel engine (or dual fuel engine) to power the drive components burns hydrocarbons on a continuous basis during operation and emits harmful emissions into the atmosphere. It also creates heat and noise. The use of an internal combustion engine to provide rotational torque also requires the use of many moving parts within the engine, transmission and through the drive system to the hoisting drums of the main drum and sandline drum as well as to the hydraulic pumps of the snubbing jack, coil tubing injector and continuous rod injector.

In each application, the use of medium/high voltage electrically powered electric motors instead provides for a surprisingly improved system at the well site.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

1. A system for powering equipment for installing or removing tubing and/or sucker rod for an oil and gas wellbore, the system comprising:
a transformer to convert received electrical power into a medium/high voltage power;
one or more transmission cables for supplying the converted electric power to a service/workover rig, snubbing jack, coil tubing injector or continuous rod injector; and
one or more electric drive motors powered by the converted electric power transmitted by the one or more transmission cable in the service/workover rig, snubbing jack, coil tubing injector or continuous rod injector.

2. The system of claim 1, wherein the received electrical power is from a high voltage transmission lines at high voltage or stepped down to low or medium voltage through a transformer

3. The system of claim 1, wherein the received electrical power is from a generator local to the wellbore powered using diesel, natural gas, or dual fuel diesel/natural gas.

4. The system of claim 1, wherein the electric drive motors create rotational torque and speed for the process of installing or removing tubing and/or sucker rod for an oil and gas wellbore.

5. The system of claim 1 further comprising:
one or more hydraulic or hydrostatic pumps coupled to the one or more electric drive motors;
wherein the one or more hydraulic or hydrostatic pumps are coupled to one or more hydraulic equipment used in the installing or removing tubing and/or sucker rod for an oil and gas wellbore.

6. A method of powering equipment for installing or removing tubing and/or sucker rod for an oil and gas wellbore, the method comprising:
transforming, using a transformer, received electrical power, to a medium/high voltage;
transmitting the transformed electrical power using one or more transmission cables;
controlling the power to one or more electrical motors using the transformed power to control the torque and speed of the one or more electrical motors; and
transferring power from the one or more electrical motors using one or more hydraulic or hydrostatic pumps and hydraulic systems to equipment for installing or removing tubing and/or sucker rod for an oil and gas wellbore.
